(19) United States
(12) Patent Application Publication
(10) Pub. No.: US 2025/0024429 A1
(43) Pub. Date: Jan. 16, 2025

(54) UNEVEN REFERENCE SIGNAL TIMING TECHNIQUES FOR WIRELESS COMMUNICATIONS

(71) Applicant: QUALCOMM Incorporated, San Diego, CA (US)

(72) Inventors: Huilin XU, Temecula, CA (US); Yuwei REN, Beijing (CN); Weimin DUAN, San Diego, CA (US)

(21) Appl. No.: 18/707,674

(22) PCT Filed: Jan. 27, 2022
(86) PCT No.: PCT/CN2022/074274

§ 371 Date: May 6, 2024

(51) Int. Cl. H04W 68/02; H04L 5/00; H04W 56/00; H04W 72/231

(52) U.S. Cl. CPC H04W 68/02; H04L 5/0051; H04W 56/0015; H04W 72/231

(57) ABSTRACT

One general aspect includes a method of wireless communication performed by a user equipment (UE). The method of wireless communication also includes receiving a configuration defining uneven reference signals in a time domain, including defining the uneven reference signals to be received before a paging early indication (PEI) and between the PEI and a paging occasion (PO); exiting a sleeping mode to receive the uneven reference signals before the PEI and between the PEI and the PO, performing a tracking loop adjustment based on the uneven reference signals, decoding a paging message after the tracking loop adjustment, and returning to the sleeping mode. Other embodiments of this aspect include corresponding computer systems, apparatus, and computer programs recorded on one or more computer storage devices, each configured to perform the actions of the methods.

### TECHNICAL FIELD

This application relates to wireless communication systems, and more particularly to reference signal timing in wireless communications.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum b ands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Furthermore, as wireless communication becomes cheaper and more reliable, expectations among consumers change.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect includes a method of wireless communication performed by a user equipment (UE). The method of wireless communication also includes receiving a configuration defining uneven reference signals in a time domain, including defining the uneven reference signals to be received before a paging early indication (PEI) and between the PEI and a paging occasion (PO); exiting a sleeping mode to receive the uneven reference signals before the PEI and between the PEI and the PO, performing a tracking loop adjustment based on the uneven reference signals, decoding a paging message after the tracking loop adjustment, and returning to the sleeping mode. Other embodiments of this aspect include corresponding computer systems, apparatus, and computer programs recorded on one or more computer storage devices, each configured to perform the actions of the methods.

One aspect includes a non-transitory computer-readable medium having program code recorded thereon. The non-transitory computer-readable medium also includes code for configuring reference signals based on one or both of paging early indication (PEI) and a paging occasion (PO) of a user equipment (UE) served by a wireless network; and code for transmitting the reference signals unevenly spaced within a time domain.

One aspect includes an apparatus. The apparatus also includes a transceiver; and a processor coupled to the transceiver and configured to: receive a configuration defining uneven reference signals in a time domain, including defining the uneven reference signals to be received before a paging early indication (PEI) and between the PEI and a paging occasion (PO); exit a sleeping mode as part of an idle mode; receive the uneven reference signals, via the transceiver, before the PEI and between the PEI and the PO; perform a tracking loop adjustment based on the uneven reference signals; and decode a paging message after the tracking loop adjustment.

One aspect includes a user equipment (UE). The user equipment also includes means for communicating with a network base station (bs) to receive a configuration defining a plurality of uneven reference signals within a paging cycle; means for waking during the paging cycle to receive a first uneven reference signal before a paging early indication (PEI), means for receiving a second uneven reference signal between the PEI and a paging occasion (PO), and means for updating a tracking loop based at least in part on the second uneven reference signal and decoding a paging message.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 is a block diagram of user equipment (EU) hardware, including multiple radio frequency (RF) chains, according to some aspects of the present disclosure.

FIG. 3 is a diagram of an example paging cycle, including reference signals, according to some aspects of the present disclosure.

FIG. 4 is a diagram of an example paging cycle, including reference signal timing, according to some aspects of the present disclosure.

FIG. 5 is a diagram of an example paging cycle, including reference signals, according to some aspects of the present disclosure.

FIG. 6 is a flow diagram of a wireless communication method according to some aspects of the present disclosure.

FIG. 7 is a flow diagram of a wireless communication method according to some aspects of the present disclosure.

FIG. 8 illustrates a block diagram of a user equipment (UE) according to some aspects of the present disclosure.

FIG. 9 illustrates a block diagram of a base station (BS) according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3 GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with a ULtra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.99999% reliability), ultra-low latency (e.g., ˜1 ms), and users with wide ranges of mobility or lack thereof, and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR system may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10.20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, sub carrier spacing may occur with 120 kHz over a 500 MHz BW. In certain aspects, frequency bands for 5G NR are separated into two different frequency ranges, a frequency range one (FR1) and a frequency range two (FR2). FR1 bands include frequency bands at 7 GHz or lower (e.g., between about 410 MHz to about 7125 MHz). FR2 bands include frequency bands in mmWave ranges between about 24.25 GHz and about 52.6 GHz. The mmWave bands may have a shorter range, buta higher bandwidth than the FR1 bands. Additionally, 5G NR may support different sets of subcarrier spacing for different frequency ranges.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5 G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Network power saving is a topic in 5G NR Rel-18 and for the upcoming 6G technologies. One of the techniques for network power saving is to reduce the transmission of broadcast and always-on signals to reduce the density of the synchronization signal block (SSB). Power saving includes reduction of network power consumption for connected mode UEs and idle/inactive mode UEs.

In NR Rel-17, a tracking reference signal (TRS) was introduced for idle/inactive mode UE power saving. There are competing concerns, though. It is generally considered that the density of TRS should be reduced to save network power, assuming that it does not affect UE power saving performance. On the other hand, for idle and inactive mode UEs, it is preferred to have frequent SSB and TRS transmissions for UE power saving.

Power consumption of an idle/inactive mode UE depends on the number of wakeups for each paging occasion (PO). More wakeups may result in more power consumption due to the higher transition power consumption overhead between sleep and wake. In addition, more frequent wakeup shrinks UE deep sleep time which may result in power waste.

For some UE implementations, one SSB/TRS is sufficient for tracking loop and automatic gain control (AGC) update for detection of paging early indication (PEI, the idle/inactive mode wakeup signal) if PEI is based on physical downlink control channel (PDCCH). If PEI is based on sequence, the PEI itself can be used for tracking loop and AGC update.

In some instances, aligning the PEI location with a SSB or TRS may allow the UE to wake up once to receive both. However, an additional SSB/TRS may be used for further tracking loop/AGC refinement for paging physical downlink shared channel (PDSCH) decoding because paging PDSCH decoding has a higher requirement for synchronization than PDCCH or sequence reception. For some reduced capability UEs, the required number of SSB/TRS between PEI and PO can be even larger.

For idle/inactive mode UEs, if the interval between two activities (e.g., SSB, TRS, PO, PEI, PDSCH) is longer than the wakeup/sleep transition time, the UE may go to sleep to preserve battery power. Otherwise, the UE may remain awake. If the number of activities is the same, squeezing the entire awake time may save more power because of less transition time and longer deep sleep time.

While this might seem to suggest a higher density SSB/TRS transmission for more UE power savings, it might negate any network power savings. For instance, because both SSB and inactive/idle mode TRS are periodic signals, a higher density SSB/TRS transmission means more network power consumption in proportion to the frequency of occurrences of SSB/TRS occasions.

Various implementations herein provide techniques for network power saving when density of SSB/TRS is reduced while maintaining UE power savings. In a first example, the system uses unevenly spaced reference signal transmissions. In another example, a specific type of uneven spacing, aperiodic transmission, may be used additionally or instead of other types of unevenly spaced reference signal timing.

In one example from the perspective of a UE, the UE may receive a configuration that defines uneven reference signals in a time domain. In other words, rather than being evenly spaced within the time domain, various implementations may configure reference signal bursts to be either more dense or less dense in some time domain locations within a paging cycle. For instance, the implementation may include defining the uneven reference signals to be received before a paging early indication (PEI) and also between the PEI and a paging occasion (PO). An example of reference signals that may be spaced unevenly within the time domain includes an SSB, and another example includes a TRS. Once the UE is configured to receive the unevenly spaced reference signals, it may continue in an idle mode, sometimes being awake, and sometimes being asleep. The UE may exit a sleeping mode to receive the uneven reference signals before the PEI and also between the PEI and the PO. The UE may perform a tracking loop adjustment based on the uneven reference signals, decode a paging message after the tracking loop adjustment and then return to the sleep mode.

Various embodiments may increase an amount of sleep time during an idle mode for the UE by placement of the reference signals within the time domain. For instance, the network may maintain a high density of reference signals around the PEI and the PO and keep a low-density elsewhere within the paging cycle in the time domain. By increasing a density of the reference signals, the UE may have multiple events (e.g., reference signal reception, PEI reception, PO) within a single wakeup time and may then go to sleep for a longer period. By contrast, lower density of the reference signals may result in more separate wakeup times or, perhaps, a longer single wakeup time to encompass multiple events, thereby decreasing an amount of sleep for the UE during a paging cycle.

From the perspective of a network BS, an example may include configuring reference signals based on one or both of PEI and PO of a UE that is served by the network. The network may configure the reference signals to be unevenly spaced within the time domain.

Aspects of the present disclosure can provide several benefits. For example, various implementations may provide power savings for both the UE and the network BS. From the point of view of the UE, an increasing density of events around the PEI and/or the PO may help to minimize an amount of wakeup time during a paging cycle of an idle mode. A reduction in the amount of wakeup time may result in power saving for the UE. Similarly for the network BS, it may be able to provide a same level of reference signal service without increasing an overall density of the reference signals themselves. Thus, the power use attributable to the reference signals by the BS may be reduced compared to a higher density reference signal regime.

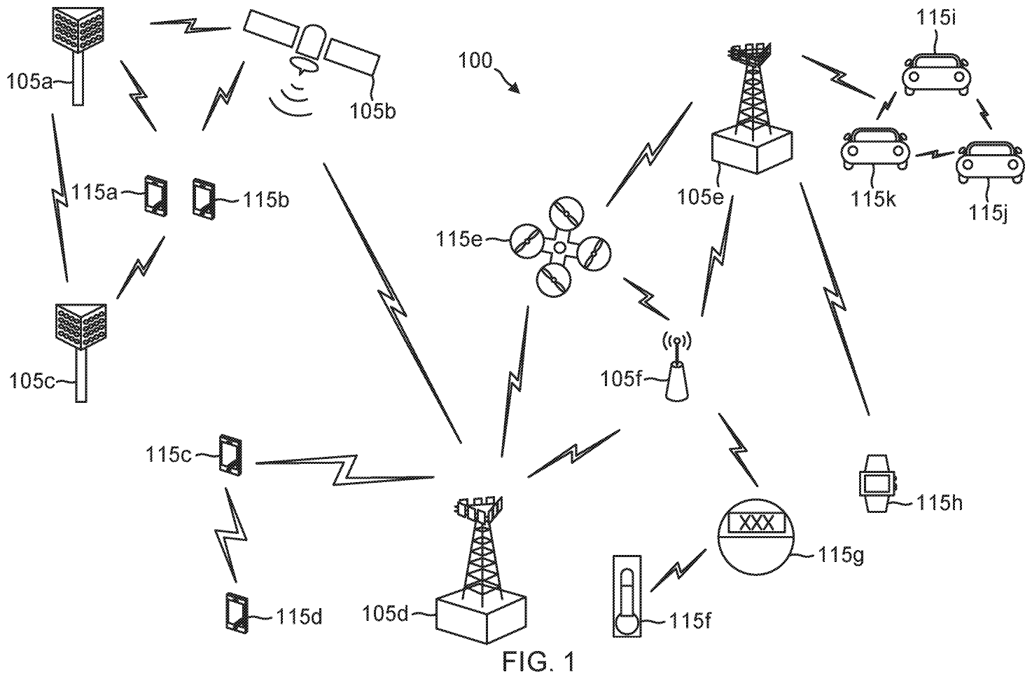

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage fora particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive IMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support communications with ultra-reliable and redundant links for devices, such as the UE 115e, which may be airborne. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of SSBs and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OS. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The BS 105 and the UE 115 may also apply HARQ for UL communications using substantially similar mechanisms as the DL HARQ.

In some aspects, a UE 115 and a BS 105 may be capable of utilizing reference signals, such as SSB and TRS, unevenly spaced in the time domain to save power by both the UE 115 and the BS 105.

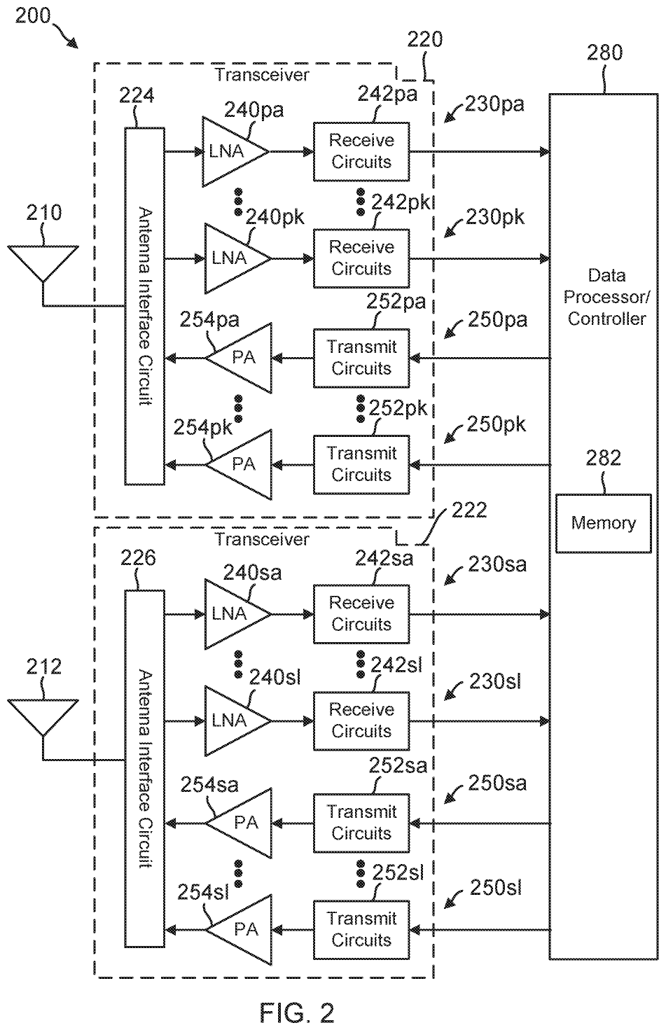

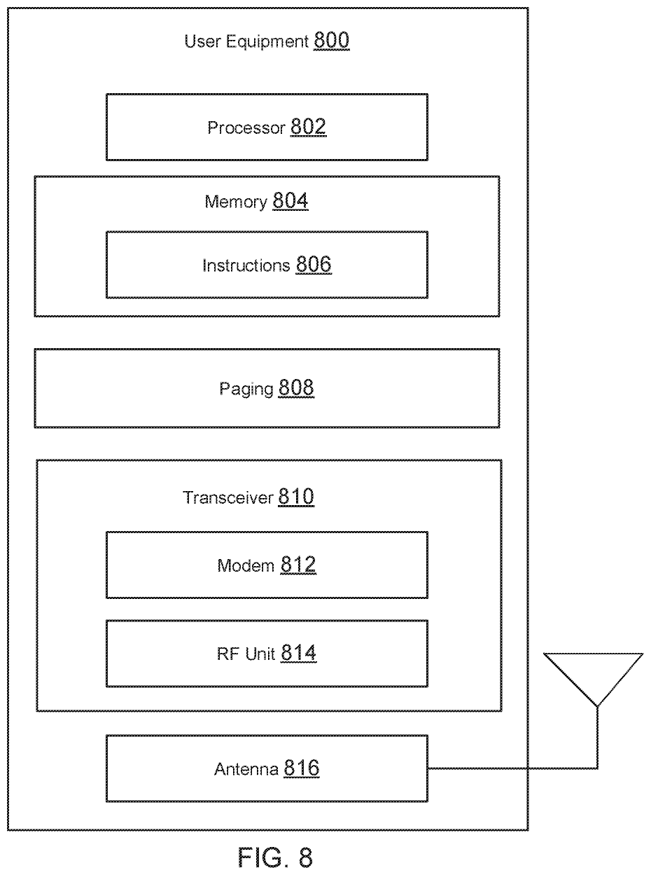

FIG. 2 illustrates an example hardware architecture for radio frequency (RF) use, which may be implemented within UE 115 (FIG. 1) or UE 800 (FIG. 8). In this exemplary design, the hardware architecture includes a transceiver 220 coupled to a first antenna 210, a transceiver 222 coupled to a second antenna 212, and a data processor/controller 280. Transceiver 220 includes multiple (K) receivers 330pa to 330pk and multiple (K) transmitters 250pa to 250pk to support multiple frequency bands, multiple radio technologies, carrier aggregation, etc. Transceiver 222 includes L receivers 330sa to 330sl and L transmitters 250sa to 250sl to support multiple frequency bands, multiple radio technologies, carrier aggregation, receive diversity, multiple-input multiple-output (MIMO) transmission from multiple transmit antennas to multiple receive antennas, etc.

During idle mode, and in a sleep duration, hardware at the processor/controller 280 may go into a low-power mode or be power-collapsed, thereby saving power. Similarly, during a wake duration of the idle mode, hardware at the processor/controller 280 may operate with enough power as is appropriate to perform paging operations, including decoding PEI or paging signals, adjusting a tracking loop, and/or the like.

In the exemplary design shown in FIG. 2, each receiver 330 includes an LNA 240 and receive circuits 242. For data reception, antenna 210 receives signals from base stations and/or other transmitter stations and provides a received RF signal, which may be routed through an antenna interface circuit 224 and presented as an input RF signal to a selected receiver. Antenna interface circuit 224 may include switches, duplexers, transmit filters, receive filters, matching circuits, etc. The description below assumes that receiver 330pa is the selected receiver, though the described operations apply equally well to any of the other receivers 330. Within receiver 330pa, an LNA 240pa amplifies the input RF signal and provides an output RF signal. Receive circuits 242pa downconvert the output RF signal from RF to baseband, amplify and filter the downconverted signal, and provide an analog input signal to data processor 280. Receive circuits 242pa may include mixers, filters, amplifiers, matching circuits, an oscillator, a local oscillator (LO) generator, a phase locked loop (PLL), etc. Each remaining receiver 330 in transceivers 220 and 222 may operate in a similar manner as receiver 330pa.

In the exemplary design shown in FIG. 2, each transmitter 250 includes transmit circuits 252 and a power amplifier (PA) 254. For data transmission, data processor 280 processes (e.g., encodes and modulates) data to be transmitted and provides an analog output signal to a selected transmitter. The description below assumes that transmitter 250pa is the selected transmitter, though the described operations apply equally well to any of the other transmitters 250. Within transmitter 250pa, transmit circuits 252pa amplify, filter, and upconvert the analog output signal from baseband to RF and provide a modulated RF signal. Transmit circuits 252pa may include amplifiers, filters, mixers, matching circuits, an oscillator, an LO generator, a PLL, etc. A PA 254pa receives and amplifies the modulated RF signal and provides a transmit RF signal having the proper output power level. The transmit RF signal may be routed through antenna interface circuit 224 and transmitted via antenna 210. Each remaining transmitter 250 in transceivers 220 and 222 may operate in a similar manner as transmitter 250pa.

FIG. 2 shows an exemplary design of receiver 330 and transmitter 250. A receiver and a transmitter may also include other circuits not shown in FIG. 2, such as filters, matching circuits, etc. All or a portion of transceivers 220 and 222 may be implemented on one or more analog (ICs, RF ICs (RFICs), mixed-signal ICs, etc. For example, LNAs 240 and receive circuits 242 within transceivers 220 and 222 may be implemented on multiple IC chips or on the same IC chip. The circuits in transceivers 220 and 222 may also be implemented in other manners.

Data processor/controller 280 may perform various functions for UE 115. For example, data processor 280 may perform processing for data being received via receivers 330 and data being transmitted via transmitters 250. Controller 280 may control the operation of the various circuits within transceivers 220 and 222. A memory 282 may store program codes and data for data processor/controller 280. Data processor/controller 280 may be implemented on one or more application specific integrated circuits (ASICs) and/or other ICs.

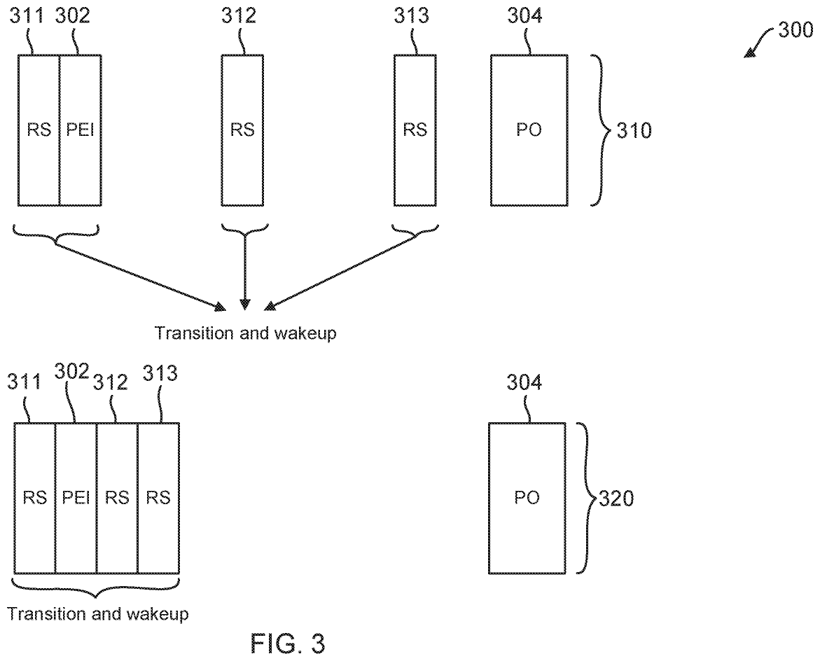

FIG. 3 is an illustration of two different scenarios 310, 320 for spacing reference signals, according to some aspects of the present disclosure. In scenario 310, the reference signals 311, 312, 313 are spaced evenly throughout the time domain of the paging cycle. Reference signal 311 is transmitted before the PEI 302 is transmitted. Reference signals 312 and 313 are transmitted between the PEI 302 and the PO 304. In this example, the reference signals 311-313 may include any appropriate reference signal, such as SSBs, TRSs, a combination of the two, or others.

Continuing with the example, scenario 310 includes the UE performing a transition from sleep to wake three different times. In the first instance, the UE transitions from sleep to wake to receive reference signal 311 and PEI 302 and then transitions from wake to sleep sometime after PEI 302 has been received. In the second instance, the UE transitions from sleep to wake and then back to sleep to receive reference signal 312. In the third instance, the UE transitions from sleep to wake and then back to sleep to receive the reference signal 313. Of course, it is understood that the UE may be in a wake state during PO 304, assuming that it is paged.

In both scenarios 310, 320, one reference signal (e.g., reference signal 311) is sufficient for tracking loop and automatic gain control (AGC) adjustment for PEI 302 detection. In this example, PEI 302 is an idle mode wakeup signal, and it can be based on physical downlink control channel (PDCCH) or based on sequence. PEI 302 may indicate whether a paging group to which the UE belongs is being paged. Aligning the location of the PEI 302 with the SSB 311 allows the UE to wake up once to receive both. In an instance in which PEI 302 is based on sequence, the PEI itself may be used for tracking loop and AGC adjustment.

Additional reference signals may be used for further tracking loop and AGC adjustment for paging decoding if the UE is paged. This is because a paging physical downlink shared channel (PDSCH) decoding may have a higher requirement for synchronization than does the PDCCH or sequence reception associated with the PEI 302. In fact, for a reduced capability UE, the required number of reference signals between PEI 302 and PO 304 may be greater than two. Accordingly, both scenarios 310 and 320 include two reference signals 312, 313 in the time domain subsequent to PEI 302 and before PO 304. In scenario 310, depending on UE implementation, it is possible that the UE would wake up only once to receive both reference signals 312, 313 or attempt to sleep between reference signals 312, 313; therefore, scenario 310 possibly includes two or three wake up periods.

Now looking to scenario 320, the reference signals 311-313 are spaced unevenly within the time domain so that they are more dense around the PEI 302 and less dense during other times of the paging cycle. In scenario 320, the UE transitions from sleep to wake to receive SSBs 311-313 as well as PEI 302 and then transitions back to sleep. As a result, the UE may have an uninterrupted sleep period between the end of SSB 313 and the beginning of PO 304. In fact, the uninterrupted sleep in scenario 320 may provide for a higher ratio of sleep time to wake time within scenario 320 than is available within scenario 310. Thus, an advantage of scenario 320 may include that it provides for a reduction in power consumption at the UE. Furthermore, to the extent that the network BS (not shown) was going to transmit three reference signal instances, the network BS used no more power than it would have otherwise in scenario 320. Additionally, the network BS was able to provide the benefits of a more dense reference signal transmission in scenario 320 without having to increase the density of reference signal transmissions throughout the entire time domain of the paging cycle.

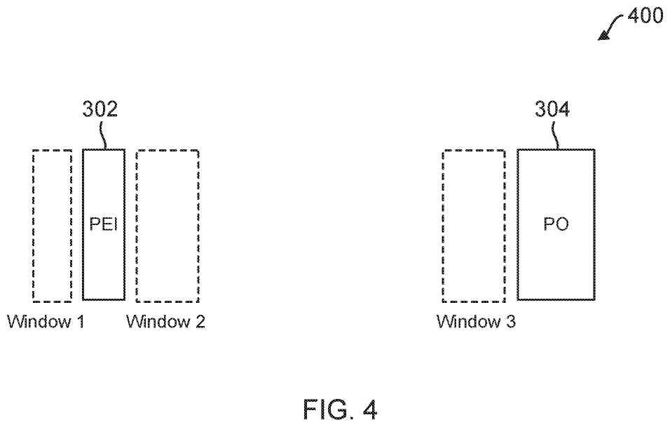

In the example of FIG. 3, various implementations include the network BS transmitting (and the UE receiving) the reference signals unevenly in time to maintain a high density of reference signals around the PEI 302 and PO 304 and a low density elsewhere. Thus, various implementations may define an uneven transmission for reference signals, such as SSBs and TRS. The underlying periodicity may be based on SSB, TRS configuration, such as by RRC, and may be overridden by a separate RRC configuration in up to three different windows. A first window may be before the PEI, using the PEI as the reference location. A second window may be after the PEI, using the PEI as a reference location. The third window may be before the target PO, using the target PO as the reference location. This is illustrated in more detail with respect to FIG. 4.

FIG. 4 is an illustration of example windows in which to define reference signal periodicity, according to one embodiment. In the example of FIG. 4, there are three windows—Window 1, Window 2, and Window 3. Window 1 is before the PEI 302 in the time domain, whereas Window 2 is after PEI 302 in the time domain.

In this example, the network configures, within each window, an offset from a reference signal burst to the reference location, a number of bursts in the window, and an interval between adjacent bursts (equivalent to periodicity within the window which is shorter than the underlying periodicity). Thus, within each window, the network may configure reference signal bursts, such as an SSB burst or a TRS burst, relative to a reference location, such as a time domain location of PEI 302 or PO 304.

In this example, a burst contains SSB or TRS transmissions, each on one beam corresponding to one transmitted SSB of a cell. Furthermore, an example SSB may contain four symbols, including SSS, PSS, and PBCH. An example TRS may include two or four symbols in one or two consecutive slots, sometimes referred to as a TRS resource set. In some examples, Window 1 may include one reference signal burst for a PDCCH-based PEI, whereas Window 1 may be omitted when the PEI 302 is sequence-based. When configuring two or more reference signal bursts for tracking loop and AGC adjustment with respect to the PO 304, some embodiments may use either one or both of Window 2 and Window 3. In other words, some embodiments may configure two or more reference signal bursts in each of Window 2 or Window 3 or may split the reference signal bursts into two different occasions, some being within Window 2 and others being within Window 3. In some examples, configuring a reference signal burst within window 2 may allow for the UE to receive a reference signal in Window 1, PEI 302, and one or more reference signals in Window 2 within a single wake instance, thereby allowing for a longer sleep period within the paging cycle. A longer sleep period may lead to the UE being able to enter a deep sleep mode, thereby saving more power.

For the uneven transmission of reference signals, Window 1 may be implicitly configured by aligning the location of PEI 302 with the reference signal for a scenario in which at most one reference signal burst is used for PEI decoding (if PDCCH based) or demodulation (if sequence based). Then network may only explicitly configure Window 2 or 3 after the alignment. However, in such a situation reference signals may be transmitted in Window 2 and 3 even if no UE is indicated as paged by the PEI 302. So, this technique essentially reorganizes the reference signal distribution to reduce transition time between sleep and awake states and increase the UE sleep time. Such technique may be suitable when the number of duty cycle of POs within the paging cycle is low.

However, to further reduce unnecessary reference signal transmission when no UE is paged in PEI 302, various implementations use aperiodic reference signal transmission, which is a particular case of uneven reference signal distribution. Specifically, transmission of the aperiodic reference signals between PEI 302 and PO 304 may be triggered if PEI 302 indicates that a paging group in which the UE is located is paged. If PEI 302 does not indicate that a paging group in which the UE is located is paged, then transmission of those aperiodic reference signals may be omitted, at least for that paging cycle. As illustrated in FIG. 4, if the paging group is paged, then there may be aperiodic reference signal transmission in either or both of Window 2 and Window 3; otherwise, Window 2 and Window 3 may not include an aperiodic reference signal transmission in that particular paging cycle.

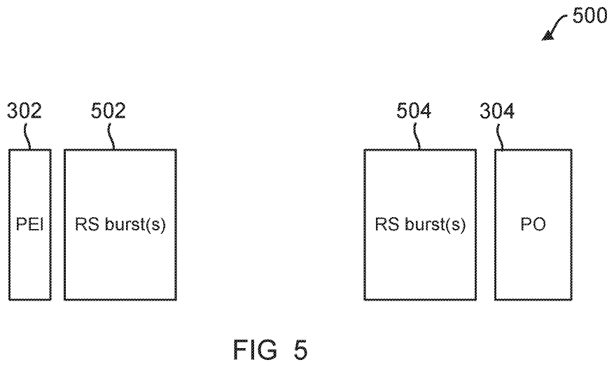

Such a scenario is illustrated in FIG. 5. FIG. 5 illustrates an example scenario in which aperiodic reference signal bursts 502, 504 are transmitted during either or both of Window 2 and Window 3. In the example of FIG. 5, the aperiodic reference signal transmission may be based on the network configuration of a starting location with respect to a reference location (e.g., time domain location of PEI 302 or PO 304), an offset between a first SSB or TRS burst to the reference location, the number of bursts to be transmitted, and an interval between adjacent bursts.

In a scenario in which the reference location is the time domain location of PEI 302, the reference signal is transmitted after PEI 302. Such an implementation may have a benefit that if UEs of multiple POs can be paged by the PEI 302, common reference signal bursts may be shared by multiple of these UEs. On the other hand, if the reference location is the time domain location of PO 304, the aperiodic reference signal may be transmitted before PO 304. This may include per-PO transmission of the aperiodic reference signal bursts. UEs in a group may not share PO times, so aperiodic reference signal bursts using the time domain location of the PO as a reference may not be shared by multiple UEs.

While this example discusses aperiodic reference signal bursts, it is understood that it is not mutually exclusive with periodic reference signals. For instance, in an example in which a UE group is not paged and thus the aperiodic reference signal bursts are not transmitted, the network BS may still continue to transmit periodic reference signals. An advantage of some embodiments is that they may save network power by having a less dense periodicity of periodic reference signals while using aperiodic reference signals to increase a time domain density when appropriate.

Depending upon the signaling scheme of PEI 302, the aperiodic reference signal bursts 502, 504 may be determined by any appropriate techniques. For instance, if PEI 302 is based on sequence, then a transmission location and number of reference signal bursts to be transmitted may be determined by network configuration in SIB. In a sequence-based PEI, PEI 302 may only indicate whether the paging group is paged, and if the paging group is not paged, then the implementation does not assume that the aperiodic reference signal bursts are transmitted.

In another example, the PEI 302 is based on PDCCH. In such an example, the transmission location and number of reference signal bursts can be either determined by network configuration in SIB or jointly determined by SIB and a configuration index in the PEI PDCCH information bits. A PDCCH-based PEI may have ample bits to indicate both the paged UEs and the configuration index of aperiodic reference signal transmission. In an instance in which the configuration index is included in PDCCH, the UE may use the corresponding configuration body in the set of configurations provided by SIB.

Aperiodic transmission of reference signal bursts may in some instances eliminate unnecessary bursts when the paging group is not paged. In other words, network power may be conserved due to less transmission, and UE power may be conserved by allowing UE hardware to remain in a sleep state instead of waking up to receive reference signal bursts.

In some examples in which the reference signal includes TRS, aperiodic TRS is transmitted only if the corresponding periodic TRS resource set is configured by the network. The following configurations for the TRS resource set can be used from the corresponding periodic TRS resource configuration: QCL (quasi co-location) reference, firstOFDMSymbolInTimeDomain, frequency DomainAllocation, startingRB, nrofRBs, powerControlOffsetSS, scramblingID in some examples. Reusing these parameters may save some signaling overhead in some implementations. The starting location and periodicity may be separately configured by, e.g., RRC.

If more than one TRS resource set is configured on a SSB beam, the network may indicate which TRS resource set is selected for aperiodic transmission. In some examples, the aperiodic TRS resource set may be selected only if the corresponding periodic TRS resource set is also transmitted. For aperiodic SSB, since only one periodic SSB is transmitted on each beam, there may be no reason to further select an aperiodic SSB transmission for that beam.

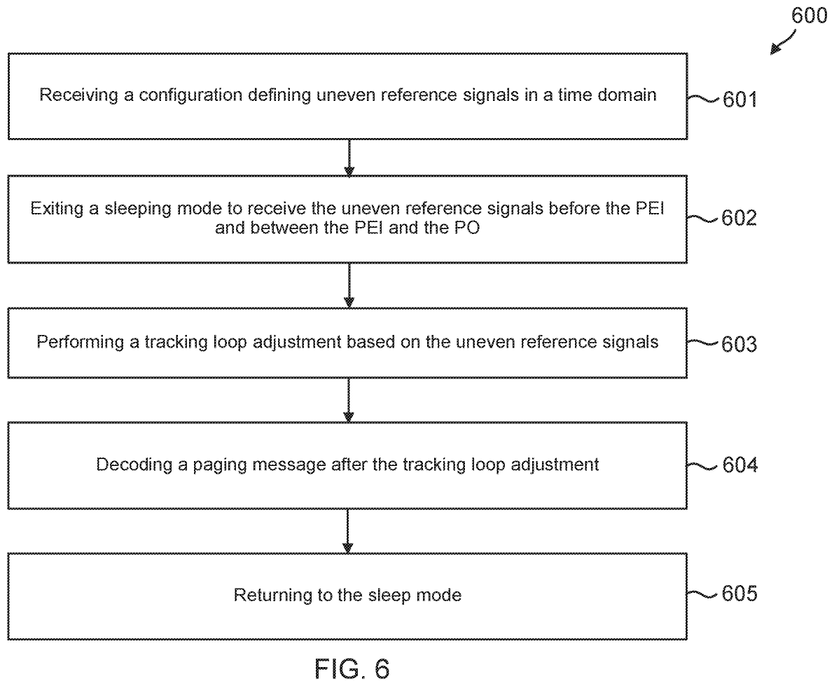

FIG. 6 is a flowchart of a communication method 600 that utilizes unevenly spaced reference signals according to some aspects of the disclosure. The method 600 may be performed by a UE (e.g., the UEs 115 and/or 800), and the method 600 may employ similar mechanisms as discussed above in relation to FIGS. 1-5. In some aspects, the UE may utilize one or more components, such as the processor 802, the memory 804, the paging module 808, the transceiver 810, the modem 812, and the one or more antennas 816 of FIG. 8, to execute the actions of method 600. As illustrated, the method 600 includes a number of enumerated actions, but aspects of the method 600 may include additional actions before, after, and in between the enumerated actions. In some aspects, one or more of the enumerated actions may be omitted or performed in a different order.

At action 601, the UE is in an idle mode and receives a configuration that defines uneven reference signals in a time domain. In some examples, the reference signals may include SSBs, TRSs, or any other appropriate reference signal. In one example, action 601 includes receiving an RRC signal that specifies periodic reference signal timing, though the periodic reference signal timing may not be entirely even in the time domain and within a particular paging cycle. For instance, as shown in FIGS. 3-4, multiple periodic signals may be configured for particular times within the paging cycle, such as before PEI, after PEI, and/or before PO. For instance, the periodic signals may be grouped in windows, such as shown in FIG. 4, where the configuration defines an offset from a reference location, a number of bursts within a window, an interval between adjacent bursts within a window, and the like.

In another example, the signals may be aperiodic and triggered when the PEI indicates that a UE group is paged. Aperiodic reference signals may be triggered by information bits within PDCCH are further configured by information within an SIB. Periodic and aperiodic signals may be used together during paging cycles so that periodic signals may provide for a less dense reference signal within the paging cycle, and aperiodic signals may be added to create a more dense reference signal when appropriate (e.g., when the PEI indicates that the UE group is paged).

At action 602, the UE exits a sleep mode to receive the uneven reference signals. The UE may exit the sleep mode to receive the reference signal and then use that reference signal for tracking loop and AGC adjustment to then receive and decode the PEI. The UE may also receive further reference signals, such as in the windows of FIG. 4, thereby enabling the UE to further perform tracking loop and AGC adjustment to perform page decoding.

At action 603, the UE performs a tracking loop adjustment using the reference signals that it has received. For example, the UE may adjust one or more PLLs or other loops at receive circuits 242 of FIG. 2 and/or may also adjust a gain at a LNA 240. At action 604, the UE decodes the paging message after the tracking loop adjustment. The paging message may or may not cause the UE to receive further information or transmit other information. At action 605, the UE returns to the sleep mode.

The scope of implementations is not limited to the series of actions 601-603. Rather, other implementations may add, omit, rearrange, or modify various actions. For instance, the UE may perform method 600 as appropriate and repeatedly during idle mode.

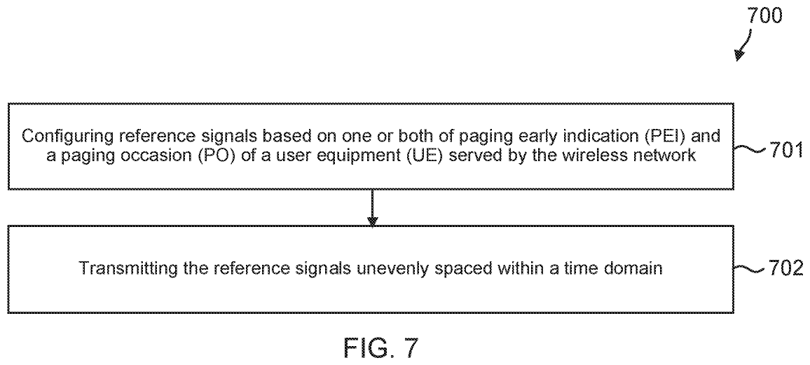

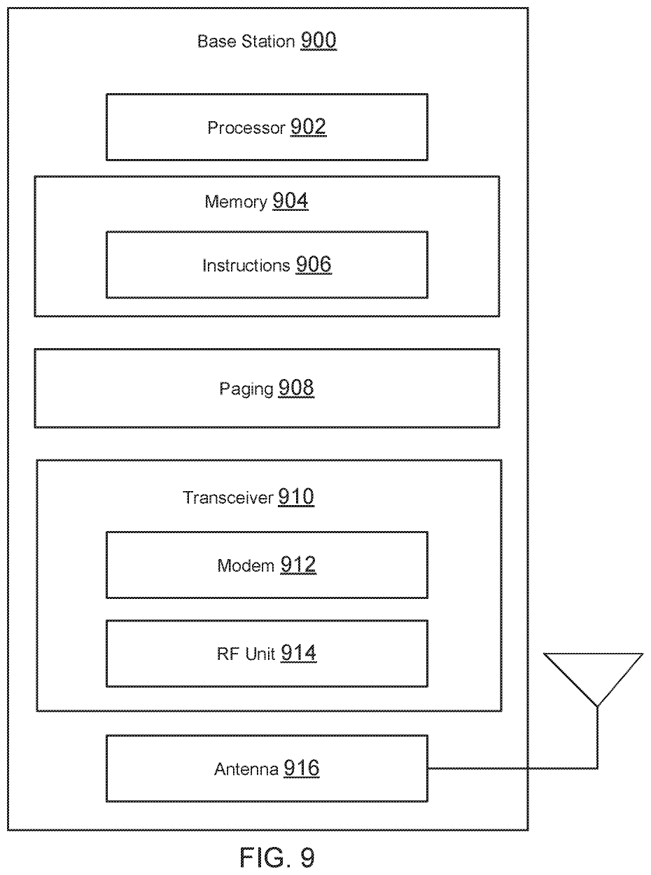

FIG. 7 is a flowchart of a communication method 700 that utilizes unevenly spaced reference signals according to some aspects of the disclosure. The method 700 may be performed by a BS (e.g., the BSs 105 and/or 900), and the method 700 may employ similar mechanisms as discussed above in relation to FIGS. 1-5. In some aspects, the BS may utilize one or more components, such as those shown in FIG. 9, to execute the actions of method 700. As illustrated, the method 700 includes a number of enumerated actions, but aspects of the method 700 may include additional actions before, after, and in between the enumerated actions. In some aspects, one or more of the enumerated actions may be omitted or performed in a different order.

At action 701, the BS configures reference signals based on one or both of the PEI and a PO of a UE that is served by the wireless network. Thus, in contrast to other systems that merely use a periodic reference signal that is configured without regard to a time domain location of the PEI or PO, various embodiments at action 701 may configure periodic and/or aperiodic reference signals unevenly in the time domain to be more dense in certain areas and less dense in other areas, as shown by example and FIGS. 3-5.

In one example, there are two time periods—a first time period before a PEI and a second time period between the PEI and a corresponding PO. Examples are shown in FIG. 4, in which the first time period may correspond to Window 1, and wherein the second time period may correspond to either one or both of Windows 2 and 3. In the first time period, the BS configures a first offset from the reference signal to the PEI, a first number of reference signal bursts and the first time period, and a first interval between any adjacent reference signal bursts. Continuing with the example, within the second time period, the network BS configures a second offset from a second reference signal burst to either the PEI or the PO, a second number of bursts and the second time period, and a second interval between any adjacent bursts.

In yet another example, action 701 may configure a first aperiodic reference signal within the first time period and configure a second aperiodic reference signal in the second time period and in response to determining that a UE group (possibly including a UE subgroup) has been paged. As noted above with respect to method 600 of FIG. 6, periodic reference signals may be configured by RRC, whereas uneven reference signals may be configured by information in SIB or information in PDCCH, though the scope of embodiments may include any appropriate technique to cause the network BS to transmit reference signals and the UE to prepare to receive the reference signals.

At action 702, the BS transmits the reference signals to the UE, which may be included in a group and/or subgroup of UEs which are paged together. As noted above, the reference signals may be unevenly spaced within the time domain, as illustrated by FIGS. 3-5.

FIG. 8 is a block diagram of an exemplary UE 800 according to some aspects of the present disclosure. The UE 800 may be the same as or similar to the UE 115 discussed above with respect to FIGS. 1-6. As shown, the UE 800 may include a processor 802, a memory 804, a paging module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 1-6. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The paging module 808 may be implemented via hardware, software, or combinations thereof. For example, the paging module 808 may be implemented as a processor, circuit, and/or instructions 806 stored in the memory 804 and executed by the processor 802.

In some aspects, the paging module 808 is configured to perform paging, including sleeping and waking, decoding PEI and page signals, adjusting tracking loop and AGC, as discussed above.

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the paging module 808 according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

In some aspects, the processor 802 may be coupled to the memory 804, the paging module 808, and/or the transceiver 810. The processor 802 and may execute operating system (OS) code stored in the memory 804 in order to control and/or coordinate operations of the paging module 808 and/or the transceiver 810.

FIG. 9 is a block diagram of an exemplary BS 900 according to some aspects of the present disclosure. The BS 900 may be a BS 105 as discussed above. As shown, the BS 900 may include a processor 902, a memory 904, a paging module 908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 1-7. Instructions 906 may also be referred to as code, which may be interpreted broadly to include any type of computer-readable statement(s).

The paging module 908 may be implemented via hardware, software, or combinations thereof. For example, the paging module 908 may be implemented as a processor, circuit, and/or instructions 906 stored in the memory 904 and executed by the processor 902.

The paging module 908 may be used for various aspects of the present disclosure, for example, aspects of FIGS. 1-7. In some aspects, the paging module 908 is configured to configure reference signals that are unevenly spaced within the time domain, such as those example shown above with respect to FIGS. 3-5.

Additionally or alternatively, the paging module 908 can be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 can be configured to communicate bi-directionally with other devices, such as the UEs 115 and/or 900. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 800. The RF unit 914 may be further configured to perform analog beamforming in conjunction with the digital beamforming. Although shown as integrated together in transceiver 910, the modem subsystem 912 and/or the RF unit 914 may be separate devices that are coupled together at the BS 900 to enable the BS 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the BS 900 can include multiple transceivers 910 implementing different RATs (e.g., NR and LTE). In some instances, the BS 900 can include a single transceiver 910 implementing multiple RATs (e.g., NR and LTE). In some instances, the transceiver 910 can include various components, where different combinations of components can implement RATs.

In some aspects, the processor 902 may be coupled to the memory 904, the paging module 908, and/or the transceiver 910. The processor 902 may execute OS code stored in the memory 904 to control and/or coordinate operations of the paging module 908, and/or the transceiver 910. In some aspects, the processor 902 may be implemented as part of the paging module 908.

Further aspects of the present disclosure include the following clauses:

1. A method of wireless communication performed by a user equipment (UE), the method comprising:
receiving a configuration defining uneven reference signals in a time domain, including defining the uneven reference signals to be received before a paging early indication (PEI) and between the PEI and a paging occasion (PO);
exiting a sleeping mode to receive the uneven reference signals before the PEI and between the PEI and the PO;
performing a tracking loop adjustment based on the uneven reference signals;
decoding a paging message after the tracking loop adjustment; and
returning to the sleeping mode.

2. The method of clause 1, wherein the uneven reference signals comprise at least one item selected from a list consisting of:
a synchronization signal block (SSB); and
a tracking reference signal (TRS).

3. The method of clauses 1-2, wherein the uneven reference signals are unevenly spaced in the time domain.

4. The method of clauses 1-3, wherein the uneven reference signals include aperiodic occurrences of the uneven reference signals.

5. The method of clauses 1-4, wherein the PEI is based on a sequence, and wherein the uneven reference signals include reference signal bursts configured by a system information block (SIB).

6. The method of clauses 1-4, wherein the PEI is based on a physical downlink control channel (PDCCH), and wherein the uneven reference signals include reference signal bursts triggered by information bits within the PDCCH.

7. The method of clauses 1-4, wherein the uneven reference signals comprise tracking reference signals (TRSs), and wherein an aperiodic burst of the TRS is conditioned upon a corresponding periodic TRS resource being transmitted.

8. A non-transitory computer-readable medium having program code recorded thereon, the program code comprising:
code for configuring reference signals based on one or both of paging early indication (PEI) and a paging occasion (PO) of a user equipment (UE) served by a wireless network; and
code for transmitting the reference signals unevenly spaced within a time domain.

9. The non-transitory computer-readable medium of clause 8, wherein the reference signals comprise at least one item selected from a list consisting of:
a synchronization signal block (SSB); and
a tracking reference signal (TRS).

10. The non-transitory computer-readable medium of clauses 8-9, wherein the reference signals are configured within a plurality of time periods, a first time period being before the PEI and a second time period being between the PEI and the PO, the non-transitory computer-readable medium including:
code for, within the first time period, configuring a first offset from a first reference signal burst to the PEI, a first number of bursts in the first time period, and a first interval between any adjacent bursts; and
code for, within the second time period, configuring a second offset from a second reference signal burst to the PO, a second number of bursts in the second time period, and a second interval between any adjacent bursts.

11. The non-transitory computer-readable medium of clauses 8-10, wherein the reference signals are configured within a plurality of time periods, a first time period being before the PEI and a second time period being between the PEI and the PO, the non-transitory computer-readable medium including:
code for, within the first time period, configuring a first aperiodic reference signal; and
code for, within the second time period, configuring a second aperiodic reference signal in response to determining that a UE group or subgroup has been paged.

12. The non-transitory computer-readable medium of clause 11, wherein the second aperiodic reference signal is configured based at least in part on a reference location, an offset between a first reference signal burst and the reference location, a number of reference signal bursts to be transmitted, and an interval between any adjacent reference signal bursts.

13. The non-transitory computer-readable medium of clause 12, wherein the reference location comprises at least one item selected from a list consisting of:
a time domain location of the PEI; and
a time domain location of the PO.

14. The non-transitory computer-readable medium of clause 11, wherein the PEI is based on a sequence, and wherein configuring the second aperiodic reference signal is based at least in part on information within a system information block (SIB).

15. The non-transitory computer-readable medium of clause 11, wherein the PEI is based on a physical downlink control channel (PDCCH), and wherein triggering the second aperiodic reference signal is based at least in part on information within the PDCCH.

16. The non-transitory computer-readable medium of clause 11, wherein the reference signals comprise tracking reference signals (TRSs), and wherein an aperiodic burst of the TRS is conditioned upon a corresponding periodic TRS resource being transmitted within the second time period.

17. An apparatus comprising:
a transceiver; and
a processor coupled to the transceiver and configured to:
   receive a configuration defining uneven reference signals in a time domain, including defining the uneven reference signals to b e received before a paging early indication (PEI) and between the PEI and a paging occasion (PO);
   exit a sleeping mode as part of an idle mode;
   receive the uneven reference signals, via the transceiver, before the PEI and between the PEI and the PO;
   perform a tracking loop adjustment based on the uneven reference signals; and
   decode a paging message after the tracking loop adjustment

18. The apparatus of clause 17, wherein the uneven reference signals comprise at least one item selected from a list consisting of:
a synchronization signal block (SSB); and
a tracking reference signal (TRS).

19. The apparatus of clauses 17-18, wherein the uneven reference signals are unevenly spaced in the time domain.

20. The apparatus of clauses 17-19, wherein the uneven reference signals include aperiodic occurrences of the uneven reference signals.

21. The apparatus of clauses 17-20, wherein the PEI is based on a sequence, and wherein the uneven reference signals include reference signal bursts configured by a system information block (SIB).

22. The apparatus of clauses 17-20, wherein the PEI is based on a physical downlink control channel (PDCCH), and wherein the uneven reference signals include reference signal bursts triggered by information bits within the PDCCH.

23. The apparatus of clauses 17-20, wherein the uneven reference signals comprise tracking reference signals (TRSs), and wherein an aperiodic burst of the TRS is conditioned upon a corresponding periodic TRS resource being transmitted.

24. A user equipment (UE) comprising:
means for communicating with a network base station (BS) to receive a configuration defining a plurality of uneven reference signals within a paging cycle;
means for waking during the paging cycle to receive a first uneven reference signal before a paging early indication (PEI);
means for receiving a second uneven reference signal between the PEI and a paging occasion (PO); and
means for updating a tracking loop based at least in part on the second uneven reference signal and decoding a paging message.

25. The UE of clause 24, wherein the plurality of uneven reference signals comprise at least one item selected from a list consisting of:
a synchronization signal block (SSB); and
a tracking reference signal (TRS).

26. The UE of clauses 24-25, wherein the first uneven reference signal includes an aperiodic occurrence.

27. The UE of clauses 24-26, wherein the second uneven reference signal includes an aperiodic occurrence.

28. The UE of clauses 24-27, wherein the PEI is based on a sequence, and wherein the plurality of uneven reference signals include reference signal bursts configured by a system information block (SIB).

29. The UE of clauses 24-27, wherein the PEI is based on a physical downlink control channel (PDCCH), and wherein the plurality of uneven reference signals include reference signal bursts triggered by information bits within the PDCCH.

30. The UE of clauses 24-27, wherein the plurality of uneven reference signals comprise tracking reference signals (TRSs), and wherein an aperiodic burst of the TRS is conditioned upon a corresponding periodic TRS resource being transmitted.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
receiving a configuration defining uneven reference signals in a time domain, including defining the uneven reference signals to be received before a paging early indication (PEI) and between the PEI and a paging occasion (PO);
exiting a sleeping mode to receive the uneven reference signals before the PEI and between the PEI and the PO;
performing a tracking loop adjustment based on the uneven reference signals;
decoding a paging message after the tracking loop adjustment; and
returning to the sleeping mode.

2. The method of claim 1, wherein the uneven reference signals comprise at least one item selected from a list consisting of:
a synchronization signal block (SSB); and
a tracking reference signal (TRS).

3. The method of claim 1, wherein the uneven reference signals are unevenly spaced in the time domain.

4. The method of claim 1, wherein the uneven reference signals include aperiodic occurrences of the uneven reference signals.

5. The method of claim 1, wherein the PEI is based on a sequence, and wherein the uneven reference signals include reference signal bursts configured by a system information block (SIB).

6. The method of claim 1, wherein the PEI is based on a physical downlink control channel (PDCCH), and wherein the uneven reference signals include reference signal bursts triggered by information bits within the PDCCH.

7. The method of claim 1, wherein the uneven reference signals comprise tracking reference signals (TRSs), and wherein an aperiodic burst of the TRS is conditioned upon a corresponding periodic TRS resource being transmitted.

8. A non-transitory computer-readable medium having program code recorded thereon, the program code comprising:
code for configuring reference signals based on one or both of paging early indication (PEI) and a paging occasion (PO) of a user equipment (UE) served by a wireless network; and
code for transmitting the reference signals unevenly spaced within a time domain.

9. The non-transitory computer-readable medium of claim 8, wherein the reference signals comprise at least one item selected from a list consisting of:
a synchronization signal block (SSB); and
a tracking reference signal (TRS).

10. The non-transitory computer-readable medium of claim 8, wherein the reference signals are configured within a plurality of time periods, a first time period being before the PEI and a second time period being between the PEI and the PO, the non-transitory computer-readable medium including:
code for, within the first time period, configuring a first offset from a first reference signal burst to the PEI, a first number of bursts in the first time period, and a first interval between any adjacent bursts; and
code for, within the second time period, configuring a second offset from a second reference signal burst to the PO, a second number of bursts in the second time period, and a second interval between any adjacent bursts.

11. The non-transitory computer-readable medium of claim 8, wherein the reference signals are configured within a plurality of time periods, a first time period being before the PEI and a second time period being between the PEI and the PO, the non-transitory computer-readable medium including:
code for, within the first time period, configuring a first aperiodic reference signal; and
code for, within the second time period, configuring a second aperiodic reference signal in response to determining that a UE group or subgroup has been paged.

12. The non-transitory computer-readable medium of claim 11, wherein the second aperiodic reference signal is configured based at least in part on a reference location, an offset between a first reference signal burst and the reference location, a number of reference signal bursts to be transmitted, and an interval between any adjacent reference signal bursts.

13. The non-transitory computer-readable medium of claim 12, wherein the reference location comprises at least one item selected from a list consisting of:
a time domain location of the PEI; and
a time domain location of the PO.

14. The non-transitory computer-readable medium of claim 11, wherein the PEI is based on a sequence, and wherein configuring the second aperiodic reference signal is based at least in part on information within a system information block (SIB).

15. The non-transitory computer-readable medium of claim 11, wherein the PEI is based on a physical downlink control channel (PDCCH), and wherein triggering the second aperiodic reference signal is based at least in part on information within the PDCCH.

16. The non-transitory computer-readable medium of claim 11, wherein the reference signals comprise tracking reference signals (TRSs), and wherein an aperiodic burst of the TRS is conditioned upon a corresponding periodic TRS resource being transmitted within the second time period.

17. An apparatus comprising:
a transceiver; and
a processor coupled to the transceiver and configured to:
receive a configuration defining uneven reference signals in a time domain, including defining the uneven reference signals to be received before a paging early indication (PEI) and between the PEI and a paging occasion (PO);
exit a sleeping mode as part of an idle mode;
receive the uneven reference signals, via the transceiver, before the PEI and between the PEI and the PO;
perform a tracking loop adjustment based on the uneven reference signals; and
decode a paging message after the tracking loop adjustment.

18. The apparatus of claim 17, wherein the uneven reference signals comprise at least one item selected from a list consisting of:
a synchronization signal block (SSB); and
a tracking reference signal (TRS).

19. The apparatus of claim 17, wherein the uneven reference signals are unevenly spaced in the time domain.

20. The apparatus of claim 17, wherein the uneven reference signals include aperiodic occurrences of the uneven reference signals.

21. The apparatus of claim 17, wherein the PEI is based on a sequence, and wherein the uneven reference signals include reference signal bursts configured by a system information block (SIB).

22. The apparatus of claim 17, wherein the PEI is based on a physical downlink control channel (PDCCH), and wherein the uneven reference signals include reference signal bursts triggered by information bits within the PDCCH.

23. The apparatus of claim 17, wherein the uneven reference signals comprise tracking reference signals (TRSs), and wherein an aperiodic burst of the TRS is conditioned upon a corresponding periodic TRS resource being transmitted.

24. A user equipment (UE) comprising:
means for communicating with a network base station (BS) to receive a configuration defining a plurality of uneven reference signals within a paging cycle;
means for waking during the paging cycle to receive a first uneven reference signal before a paging early indication (PEI);
means for receiving a second uneven reference signal between the PEI and a paging occasion (PO); and
means for updating a tracking loop based at least in part on the second uneven reference signal and decoding a paging message.

25. The UE of claim 24, wherein the plurality of uneven reference signals comprise at least one item selected from a list consisting of:
a synchronization signal block (SSB); and
a tracking reference signal (TRS).

26. The UE of claim 24, wherein the first uneven reference signal includes an aperiodic occurrence.

27. The UE of claim 24, wherein the second uneven reference signal includes an aperiodic occurrence.

28. The UE of claim 24, wherein the PEI is based on a sequence, and wherein the plurality of uneven reference signals include reference signal bursts configured by a system information block (SIB).

29. The UE of claim 24, wherein the PEI is based on a physical downlink control channel (PDCCH), and wherein the plurality of uneven reference signals include reference signal bursts triggered by information bits within the PDCCH.

30. The UE of claim 24, wherein the plurality of uneven reference signals comprise tracking reference signals (TRSs), and wherein an aperiodic burst of the TRS is conditioned upon a corresponding periodic TRS resource being transmitted.
